(19) United States
(12) Patent Application Publication
(10) Pub. No.: US 2023/0410104 A1
(43) Pub. Date: Dec. 21, 2023

(54) DIGITAL ASSET TRANSACTION PLATFORM AND SYSTEM

(71) Applicant: Michael Towles, Springfield, VA (US)

(72) Inventor: Michael Towles, Springfield, VA (US)

(21) Appl. No.: 18/247,031

(22) PCT Filed: May 10, 2022
(86) PCT No.: PCT/US2022/028588

§ 371 Date: Mar. 28, 2023

Related U.S. Application Data
(60) Provisional application No. 63/186,769, filed on May 10, 2021.

(51) Int. Cl. G06Q 20/38; G06Q 30/0645

(52) U.S. Cl. CPC G06Q 20/389; G06Q 30/0645

(57) ABSTRACT

A system managing software program transactions and use has an Internet platform with a server and a processor coupled to a data repository, executing software providing interactive interfaces to users, stored profiles for registered users of the system, and an inventory of the software programs for sale or rent, each software program defined by a Smart Contract (SC) in a Blockchain. The system is characterized in that a registered user selects a software program, and the system interacts with the registered user to agree to a price and terms of use, the agreed price and terms of use are instantiated by the system in a non-fungible token (NFT) minted by the SC, the NFT is populated with critical properties, the NFT is associated with a profile for the registered user, recorded in a Software Title Ledger, and the software program is provided to the registered user ready to execute.

### CROSS REFERENCE OF RELATED DOCUMENTS

The present application is a National Entry from PCT/US2022/028588 filed May 10, 2022 having priority to a U.S. provisional application 63/186,769 filed May 2021.

### BACKGROUND OF THE INVENTION

### 1. Field of the Invention

The present invention is in the technical field of license management for digital assets and pertains more particularly to managing licenses to digital assets with fungible tokens in Blockchain operations.

### 2. Description of Related Art

Digital assets, as known in the art, include any content that's stored digitally. That might mean images, photos, videos, files containing text, spreadsheets, or slide decks. New digital assets enter consumer markets, daily. A digital asset can be any content, in any format, that is stored digitally and provides value.

Some digital assets are controlled by a license, such as software use. Software is used in this specification as a digital asset to describe the management of digital assets in general in embodiments of the present invention.

Every business enterprise uses software to manage business processes, communicate with employees, customers, and vendors, and for myriad other purposes. In most instances, software products require activating licenses or agreeing to terms and conditions before software programs can be downloaded, installed, or accessed.

A software license is a contract between the entity that created the software and an end user of the software. The software license is typically a text document designed to protect the intellectual property of the software developer and to limit any claims against the developer that may arise from its use.

A software license also provides legally binding definitions for the distribution and use of the software. End-user rights, such as installation, warranties, and liabilities, are also often spelled out in the software license, including protection of the developer's intellectual property.

A serious problem exists in the conventional art, wherein users often pay for a license and end up with time left on their licenses, even though they no longer require use of the software. In this situation the remaining time on the license is just a loss to the user. What is needed is a computerized platform and mechanisms enabling secondary transactions to take place between a software owner and a software purchaser/user.

### BRIEF SUMMARY OF THE INVENTION

In an embodiment of the present invention a system for managing software program transactions and use is provided, comprising an Internet platform having a server with a processor coupled to a data repository, the processor executing operating software providing interactive interfaces to users employing computerized devices coupled to the platform through Internet Service Providers (ISPs), stored profiles for registered users of the system, and an inventory of the software programs for sale or rent, with titles and characteristics recorded in the data repository, each software program defined by a Smart Contract (SC) in a Blockchain. The system is characterized in that a registered user, through individual ones of the interactive interfaces, selects a software program, and the system interacts with the registered user to agree to a price and terms of use, the agreed price and terms of use are instantiated by the system in a non-fungible token (NFT) minted by the SC, the NFT is populated with critical properties, the NFT is associated with a profile for the registered user, recorded in a Software Title Ledger, and the software program is provided to the registered user ready to execute.

In one embodiment of the system the software program is provided to the registered user by a download process through the registered user's Internet connection. Also, in one embodiment the critical properties comprise at least software program title and version, owner ID, initial purchase price, date and time. Also, in one embodiment the critical properties further comprise an end-of-life (EOL) date and time for the software program, amortized value and identifiers for tracking state of the NFT. And in one embodiment the system further comprises functionality wherein, as a user executes the software program, the platform checks the NFT properties of the software program against the Software Title Ledger.

In one embodiment the system further comprises functionality wherein, at EOL, the software program is removed from the user's platform. Also, in one embodiment the registered user ceases use prior to the EOL, and the software program is listed as a used software program, and properties of the NFT are altered accordingly. And in one embodiment a registered user purchases a used software program, and NFT properties are altered accordingly.

In another aspect of the invention a method for managing software program transactions and use is provided, comprising logging in as a registered user to an Internet-connected platform having a server with a processor coupled to a data repository, the processor executing software providing interactive interfaces to registered users employing computerized devices coupled to the platform through Internet Service Providers (ISPs), the data repository storing profiles for registered users and an inventory of software programs for sale or rent by a host of the platform, with titles and characteristics, negotiating a purchase or a rental of an individual one of the inventory of software programs by the registered user through individual ones of the interactive interfaces. instantiating a license for the software program as a non-fungible token (NFT) minted by a Smart Contract created on a Blockchain, defining permanent and variable properties for the software program, and recording the license on a Software Title Ledger, populating the NFT with critical properties, associating the NFT with the registered user's profile, and providing the software program to the registered user ready to execute.

In one embodiment the method comprises providing the software program to the registered user by a download process through the registered user's Internet connection. Also, in one embodiment the critical properties comprise at least software program title and version, owner ID, initial purchase price, date and time. Also, in one embodiment the critical properties further comprise an end-of-life (EOL) date and time for the software program, amortized value and identifiers for tracking state of the NFT. Also, in one embodiment the method further comprises wherein, as a user executes the software program, the platform checks the NFT properties of the software program against the Software Title Ledger. In one embodiment the method comprises functionality removing the software program from the user's platform at EOL. And in one embodiment the method comprises the registered user ceasing to use the software program prior to the EOL, and the software program being listed as a used software program and altering properties of the NFT accordingly. In a further embodiment the method comprises purchasing a used software program by a registered user and altering NFT properties accordingly.

### BRIEF DESCRIPTION OF THE SEVERAL VIEWS OF THE DRAWINGS

FIG. 1 is an architectural diagram in an embodiment of the invention.

FIG. 2 is a flow diagram Illustrating steps in managing a digital asset according to an embodiment of the invention.

FIG. 3 is a flow diagram illustrating steps in using and reselling software by a user in an embodiment of the invention.

### DETAILED DESCRIPTION OF THE INVENTION

The inventor in one embodiment has created a crypto-blockchain-based ecommerce process rendering a software license as a non-fungible token (NFT) for sale, rent, lease and resale purposes. The invention is not limited to managing rights to software, which is used here as an example for management of all sorts of digital assets.

Non-fungible tokens are cryptographic data entities on a blockchain with unique identification codes and metadata that distinguish the NFTs from one another. Blockchain is the foundational technology of crypto currency and NFT digital art forms, and of a variety of other data storage and verification methodology. At heart blockchain is a digital transaction ledger. A block in a Blockchain is a series of transactions grouped together, certified through cryptographic algorithms, and then added to a Blockchain ledger chronologically. At the end of each block there is a pointer to the next block that is then certified to be the transactional order of processing.

A NFT is cryptographically generated via blockchain mining to have a unique signature and properties which certify the NFT as non-fungible. By using NFTs as representative of a purchasable license for a digital asset, such as a version of a software program, the software may be bought and sold among users with a novel platform. While the running code may be the same for each different purchaser, the NFT representing the license may be unique. Every NFT is individually recognizable even though there may be thousands of the same software licenses represented by the NFTs. This is akin to having a digital NFT for a physical object like a Blue Honda Civic but being able to distinguish it from other Blue Honda Civics by its VIN number and other identifiers.

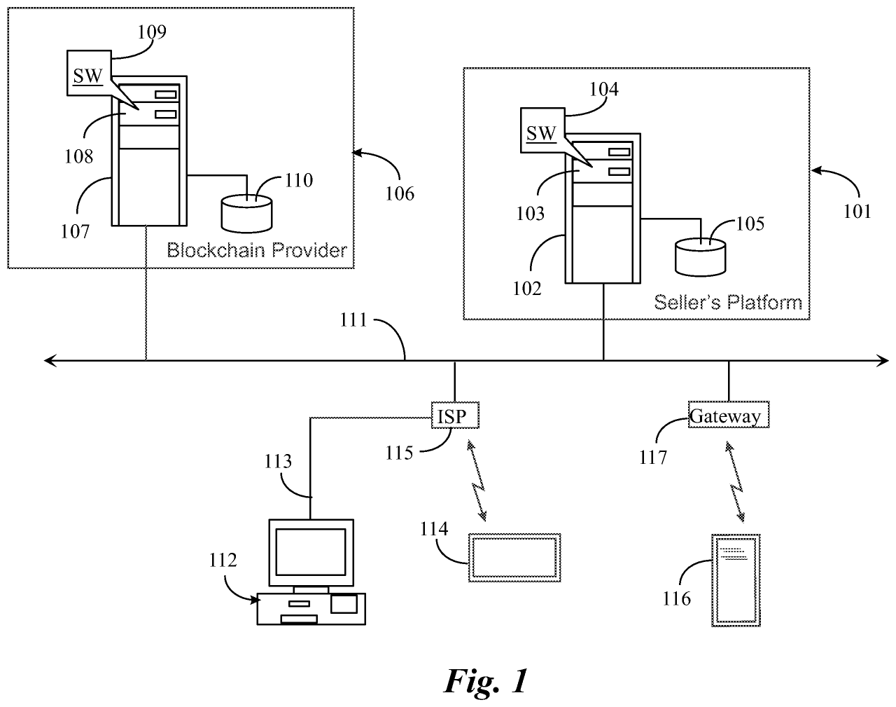

FIG. 1 is an architectural diagram in an embodiment of the invention. In the system depicted in FIG. 1 a digital asset owner's platform 101, labeled Seller's Platform, has at least one Internet-connected server 102 coupled to a data repository 105. Server 102 has a processor 103 executing software 104 from data repository 105. An asset owner represented by platform 101 may be selling software or any of a variety of digital assets, but software will continue to be used here as an example.

Server 102 is coupled to an Internet backbone 111 that represents all of the various and interconnected networks that comprise the well-known Internet network. Individual end users and enterprises as end users may connect to Seller's Platform 101. These end users are represented as employing general purpose computers represented by computer 112 connected by line 113 to an Internet Service Provider (ISP) 115 which connects the computer to Internet backbone 111 and hence to Seller's Platform 101. Other end users may employ other computerized apparatus such as Pad devices represented by device 114, which is shown connecting wirelessly to ISP 115, hence to the Seller's Platform and server 102. Smartphone 116 represents end users employing smartphones to connect through a gateway 117 to the Internet backbone and hence to the Seller's Platform and server 102.

In operation users (sellers, buyers, renters), to take advantage of services provided, will register with the entity providing the enterprise hosting platform 101 and will have log-in credentials and may set up a profile with other information stored on the platform. Server 102 executes SW 104, which provides all registration, vetting, sales, rentals, purchases and other management functions. In one implementation platform 101, through server 102, may offer a license to enable access to any one of a variety of software programs, under a variety of circumstances, including a set period of time. The platform software provides interactive interfaces to end users to select, demo and purchase software, to choose among a variety of conditions and terms for use, and to transact a sale for a license to access a particular software, as well a variety of other functions.

In one embodiment of the invention licenses are minted as non-fungible tokens (NFTs) through Smart Contracts recorded in a Blockchain through association with a Blockchain provider 106 also connected to Internet backbone 111, the Blockchain provided being operated via a server 107 with a processor 108 executing SW 109 and interacting with a data repository 110. It may be assumed that data repository 110, as well as data repository 105 may be a cloud service as well as a local memory device. In operations, creating and managing licenses for use of digital assets like specific versions of software programs interaction between software functions on platform 101 and functionality on Blockchain provider's platform 106 may be through Application Software program Interfaces (APIs).

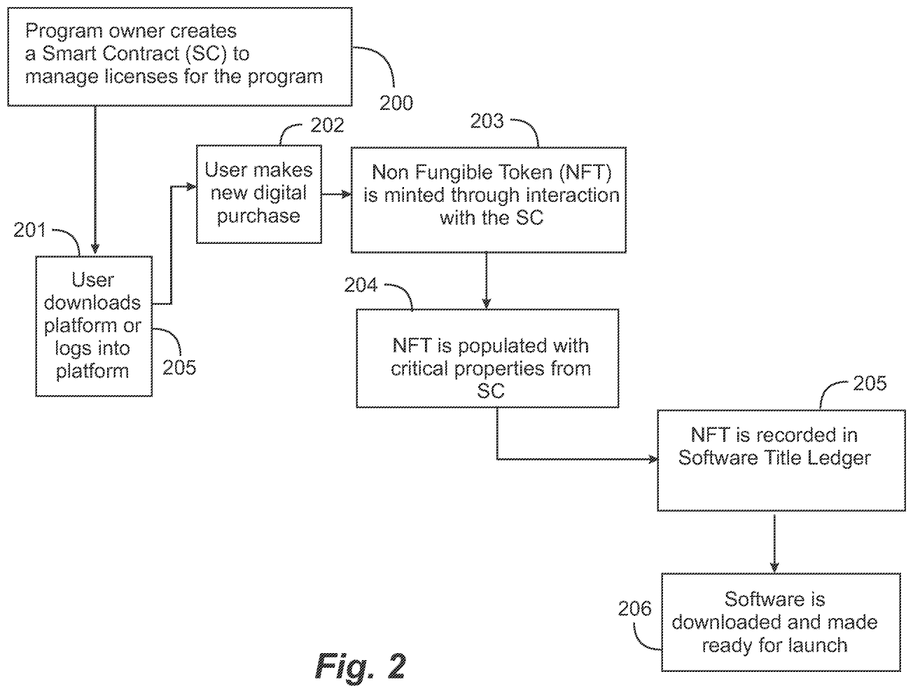

FIG. 2 is a flowchart illustrating a process whereby software programs may be licensed and managed as NFTs. At step 200 a software program owner, who may host platform 101, or may subscribe to services offered through platform 101, creates a Smart Contract (SC) to automatically manage licenses for the software program and manage/update NFTs and ledgers. The SC is a contract stored on a Blockchain that defines an agreement, in this circumstance between the software program seller and any end user of the software program, and also has software that executes when predetermined conditions are met. An SC is typically used to automate execution of an agreement so that all participants can be immediately certain of the outcome, without any intermediary's involvement or time loss, in addition to updating ledgers of NFTs.

In this instance the SC is populated with some permanent properties and some variable properties. The SC is designed in this circumstance to mint an NFT defining a license for a version of the software program, the license negotiated between end users and the seller for each sale of the software program. Once the variable properties are fixed in negotiation at the seller's platform, both the variable and the permanent properties are automatically assigned to the NFT minted for the license and the ledger associated with the NFT is updated.

A comprehensive list of properties of the SC and hence the NFT minted is listed below:

Permanent:
Software Title
Software Developer
Software Publisher
Creation method (manual, platform, api)
Creator ID
NFT Creation Date
NFT original purchase date
NFT identifier number
NFT SKU
NFT Software Key (if needed)
Original purchase price

Variable:
NFT owner
NFT repurchase date
NFT status (new or unpurchased/purchased)
NFT available for rent (Boolean)
NFT rental status (rented/not-rented)
NFT value
Description
Hosting additional margin (additional cost of hosting/delivery if desired)
Current purchase price (sale from platform to user)
Current re-purchase price (sale from user to platform/other user)
Current rental price
Platforms Availability (enumeration of platforms license may be used on)
Terms and Conditions of use.

Returning to FIG. 2, at step 201 an end user downloads the platform or logs in to the platform. Before transacting a license for a software program, the end user must register, or if already registered, log in securely to the platform. At step 202 the end user elects to make a new digital purchase of a version of the software program offered by the seller. This transaction and negotiation is managed through interactive interfaces provided by platform 101 through SW 104. Interaction between platform 101 and Blockchain platform 106 accesses the SC, which mints a NFT defining the license agreed to. The NFT is populated with the permanent and variable properties, the variable properties rendered permanent for the NFT by the agreed to conditions between the seller and the end user. It is the codification of the variable properties that renders the NFT non fungible.

At step 205 the new license as NFT is recorded in Software Title Ledger 205, and at step 206 the agreed-to version of the software program is downloaded by the end user and made ready for launch.

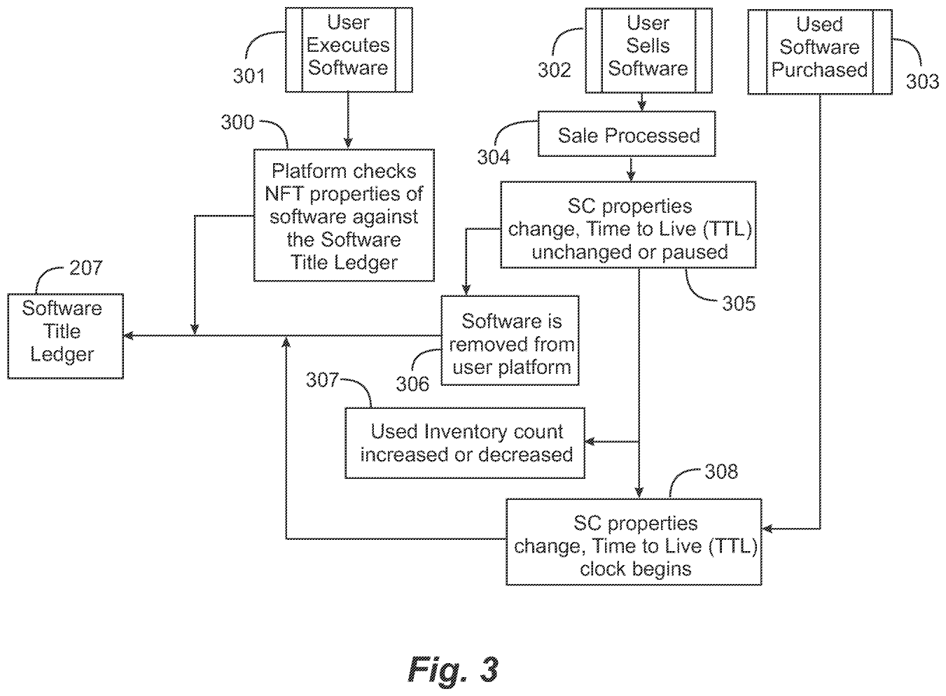

FIG. 3 represents transactions and modifications that may occur to an NFT after initial purchase and blockchain tracking. At step 301, the user executes the software, the platform checks NFT properties of the software against the software ledger at step 300 including at least ownership rights, time-to live (TTL), license state of New or Used and other properties like current values, price paid, and so on. Especially where amortization is involved, once a new software is recorded with price, the value of software license that have a set life may be dynamically evaluated reflecting a purchase price when the user that bought it new decides to transact or sell the software on the platform.

The end user may decide to sell the software at step 302, back to the platform, or to another user via the platform. The sale is processed at step 304, again through interactive interfaces provided to the end user through the platform. At step 305 the SC properties change including at least ownership, value, used purchase date, etc. on the ledger. The SC property change causes the NFT ledger to also change. The TTL may stay the same or may be paused at step 305 while being held on the platform waiting on a buyer to purchase the balance of the software license from the platform. An inventory count at the platform is increased or decreased accordingly at step 307. At step 306 the software is removed from the user's ID on the platform. Another user may choose to purchase the used software at step 303. At step 308 SC properties change such as ownership, value or amortized value, purchase date, etc. on the ledger, and the TTL clock starts. The process ends back at software ledger 207, waiting for a new transaction.

In one embodiment the value of a license may be diminished based on a time component through original purchase date (OPD) and subsequent length of period from current time (now). This depreciation of value may then be set as the price of the used license and the used license may be resold at that price.

In one embodiment the license may also be rentable, so licenses may be rented for perhaps a monthly fee. In one embodiment there may be a lease period in rental, and in one embodiment the rental may be month to month.

This method of software sales and management allows for the ownership property of the NFT software license to be modified during the purchase transaction. This ownership property is then logged at least by each transaction and time, date of purchase as well as the TTL left on the software license, against the Blockchain ledger. The sold NFT license can then be considered used. A used NFT license would not re-incur the cost of mining and be re-sellable by the software seller.

Creating an inventory of new and used NFT licenses allows for a variety of business models. Likely, but not limited to, business models can include sharing new license revenue with the software vendor while used licenses can be re-sold at any margin without profit splitting. This whole process in essence transforms business models of the likes of companies like GameStop (who buy physical games of Blu-ray/DVD and resell them) from physical to virtual.

The person of ordinary skill will understand that the embodiments described above are entirely exemplary, and that the examples are not limiting to the scope of the invention. The scope of the invention is limited only by the claims.

1. A system for managing software program transactions and use, comprising:
an Internet platform having a server with a processor coupled to a data repository, the processor executing operating software providing interactive interfaces to users employing computerized devices coupled to the platform through Internet Service Providers (ISPs);
stored profiles for registered users of the system;
an inventory of the software programs for sale or rent, with titles and characteristics recorded in the data repository, each software program defined by a Smart Contract (SC) in a Blockchain;
characterized in that a registered user, through individual ones of the interactive interfaces, selects a software program, and the system interacts with the registered user to agree to a price and terms of use, the agreed price and terms of use are instantiated by the system in a non-fungible token (NFT) minted by the SC, the NFT is populated with critical properties, the NFT is associated with a profile for the registered user, recorded in a Software Title Ledger, and the software program is provided to the registered user ready to execute.

2. The system of claim 1 wherein the software program is provided to the registered user by a download process through the registered user's Internet connection.

3. The system of claim 1 wherein the critical properties comprise at least software program title and version, owner ID, initial purchase price, date and time.

4. The system of claim 3 wherein the critical properties further comprise an end-of-life (EOL) date and time for the software program, amortized value and identifiers for tracking state of the NFT.

5. The system of claim 1 further comprising functionality wherein, as a user executes the software program, the platform checks the NFT properties of the software program against the Software Title Ledger.

6. The system of claim 4 comprising functionality wherein, at EOL, the software program is removed from the user's platform.

7. The system of claim 6 wherein the registered user ceases use prior to the EOL, and the software program is listed as a used software program, and properties of the NFT are altered accordingly.

8. The system of claim 7 wherein a registered user purchases a used software program, and NFT properties are altered accordingly.

9. A method for managing software program transactions and use, comprising:
logging in as a registered user to an Internet-connected platform having a server with a processor coupled to a data repository, the processor executing software providing interactive interfaces to registered users employing computerized devices coupled to the platform through Internet Service Providers (ISPs), the data repository storing profiles for registered users and an inventory of software programs for sale or rent by a host of the platform, with titles and characteristics;
negotiating a purchase or a rental of an individual one of the inventory of software programs by the registered user through individual ones of the interactive interfaces;
instantiating a license for the software program as a non-fungible token (NFT) minted by a Smart Contract created on a Blockchain, defining permanent and variable properties for the software program, and recording the license on a Software Title Ledger;
populating the NFT with critical properties;
associating the NFT with the registered user's profile; and
providing the software program to the registered user ready to execute.

10. The method of claim 9 comprising providing the software program to the registered user by a download process through the registered user's Internet connection.

11. The method of claim 9 wherein the critical properties comprise at least software program title and version, owner ID, initial purchase price, date and time.

12. The method of claim 11 wherein the critical properties further comprise an end-of-life (EOL) date and time for the software program, amortized value and identifiers for tracking state of the NFT.

13. The method of claim 9 further comprising functionality wherein, as a user executes the software program, the platform checks the NFT properties of the software program against the Software Title Ledger.

14. The method of claim 12 comprising functionality removing the software program from the user's platform at EOL.

15. The method of claim 12 comprising the registered user ceasing to use the software program prior to the EOL, and the software program being listed as a used software program, and altering properties of the NFT accordingly.

16. The method of claim 15 comprising purchasing a used software program by a registered user, and altering NFT properties accordingly.
